(19) United States
(12) Patent Application Publication
(10) Pub. No.: US 2008/0212890 A1
(43) Pub. Date: Sep. 4, 2008

(54) Systems and Methods for Noise Estimation in a Single Frame of Video Data

(76) Inventors: Natalya Y. Loubachevskaia, Irvine, CA (US); Mohammad Usman, Mission Viejo, CA (US)

Correspondence Address: PATENTMETRIX, 14252 CULVER DR. BOX 914, IRVINE, CA, 92604, US

(21) Appl. No.: 11/971,868

(22) Filed: Jan. 9, 2008

Related U.S. Application Data
(60) Provisional application No. 60/884,361, filed on Jan. 10, 2007.

(51) Int. Cl. G06K 9/40

(52) U.S. Cl. 382/260

(57) ABSTRACT

The present invention is directed, in at least one embodiment, to a method of estimating noise and, subsequently, filtering noise in a single frame of video data. The method comprises the steps of obtaining a single frame of video data within a memory and executing a plurality of instructions within a processor wherein, when executed, the instructions identify a window within the single frame, compute a variance of the window, derive a noise estimation from the variance, and filter the noise from the single frame using the noise estimation. The method is effective to remove Gaussian noise and blocky noise.

### CROSS-REFERENCE

The present application relies upon, for priority, U.S. Provisional Application No. 60/884,361 filed on Jan. 10, 2007.

### FIELD OF THE INVENTION

The present invention relates generally to the processing of video images and, more specifically, to methods and systems for noise estimation implemented in a processor.

### BACKGROUND OF THE INVENTION

Video processing often introduces significant noise. One source of noise, Gaussian noise, is generated from random interference and/or the random distribution of artifacts. It is often introduced in the course of the transmission of video.

A second source of noise is introduced by the encoding-decoding process, referred to as blocky noise. More specifically, the coding schemes employed in video processing generate decompressed images that sometimes exhibit artificial discontinuities between image blocks. These blocking artifacts are caused, at least in part, by quantization during the quantization step of the compression process. For example, in block-based coding, such as discrete cosine transform (DCT), monotone areas of the original image, where the pixel intensity changes gradually, suffer from the abrupt changes across the block boundary, leading to blocking artifacts. Also, visually annoying noise near real edges, which is called ringing noise, occurs in the block-based DCT scheme.

Prior art approaches to estimating noise are unable to effectively estimate both Gaussian noise and blocky noise and are particularly unable to estimate both Gaussian noise and blocky noise based on just a single frame of data. Being able to estimate both Gaussian noise and blocky noise using a single data frame is particularly useful in cases where processing speed and the efficient use of processor resources are essential to the delivery of high quality video.

What is needed is a system and method, implemented on a processor, for estimating noise in a manner that minimizes artifacts and errors while still being resource and computationally efficient. In particular, what is needed is a system and method for estimating both blocky and Gaussian noise using just a single frame of video.

### SUMMARY OF THE INVENTION

The present invention is directed, in at least one embodiment, to a method of estimating noise and, subsequently, filtering noise in a single frame of video data. The method comprises the steps of obtaining a single frame of video data within a memory and executing a plurality of instructions within a processor wherein, when executed, the instructions identify a window within the single frame, compute a variance of the window, derive a noise estimation from the variance, and filter the noise from the single frame using the noise estimation. The method is effective to remove Gaussian noise and blocky noise.

The window is identified by obtaining a plurality of windows within said frame wherein each window comprises M×N pixels and wherein the plurality of windows are separated by a predetermined number of pixels. In one embodiment, M is equal to 32, N is equal to 32 and the predetermined number of pixels is 3.

The instructions calculate the maximum pixel values for each plurality of windows comprising M×N pixels. The instructions also calculate the minimum pixel values for each plurality of windows comprising M×N pixels. The instructions compare the minimum pixel values and the maximum pixel values to at least one threshold value. The instructions eliminate windows from a variance calculation if the minimum pixel values for the windows are below the threshold value or if the maximum pixel values for the windows are above the threshold value. The instructions calculate the variance for windows wherein the windows have minimum pixel values for the windows below the threshold value and the windows have maximum pixel values for the windows above the threshold value.

The instructions also calculate the homogeneity for windows wherein the windows have minimum pixel values for the windows below the threshold value and the windows have maximum pixel values for the windows above the threshold value. The instructions obtain an array of variances. The variances in the array are sorted and the instructions compute a reference variance from the array of variances. The noise standard deviation is derived from said reference variance and the noise estimation is derived from said noise standard deviation.

In another embodiment, the present invention is directed to a method of filtering Gaussian noise and blocky noise in a single frame of video data by obtaining a single frame of video data within a memory and executing a plurality of instructions within a processor wherein, when executed, the instructions identify a plurality of windows within said single frame, select a subset of said windows based on whether a maximum pixel value for each of said windows exceeds a threshold value and whether a minimum pixel value for each of said windows is below said threshold value, compute variances for said selected subset of windows, compute an array of variances based upon said computed variances, derive a reference variance from said array of variances, derive a noise standard deviation from said reference variance, derive a noise estimation from said noise standard deviation, and filter said noise from said single frame using said noise estimation. The instructions eliminate windows from a variance calculation if the minimum pixel values for the windows are below the threshold value or if the maximum pixel values for the windows are above the threshold value. The instructions calculate a homogeneity for windows wherein the windows have minimum pixel values for the windows below the threshold value and the windows have maximum pixel values for the windows above the threshold value.

In another embodiment, the present invention is directed to a system for filtering Gaussian noise and blocky noise in a single frame of video data comprising a memory for storing a single frame of video data, a processor in data communication with said memory, and a plurality of instructions stored within a memory accessible to said processor wherein, when executed, the instructions identify a plurality of windows within the single frame, select a subset of the windows based on whether a maximum pixel value for each of the windows exceeds a threshold value and whether a minimum pixel value for each of the windows is below the threshold value, compute variances for the selected subset of windows, compute an array of variances based upon the computed variances, derive a reference variance from the array of variances, derive a noise standard deviation from the reference variance, derive a noise estimation from the noise standard deviation, and filter the noise from the single frame using the noise estimation.

### BRIEF DESCRIPTION OF THE DRAWINGS

These and other features and advantages of the present invention will be appreciated as they become better understood by reference to the following Detailed Description when considered in connection with the accompanying drawings, wherein:

FIG. 1 is a flow chart depicting the major steps of the noise estimation method of the present invention;

FIG. 2 describes steps in computing the array of minimization parameter P and the array of variances as carried out in the noise estimation method of the present invention;

FIG. 3 illustrates the computation of the value of homogeneity for a 32×32 window; and

FIG. 4 is a flow chart depicting a method of computing noise standard deviation according to the present invention.

### DETAILED DESCRIPTION OF THE INVENTION

The present invention is a system and method, implemented on a processor, for estimating noise in a video image. The present invention will presently be described with reference to the aforementioned drawings. Headers will be used for purposes of clarity and are not meant to limit or otherwise restrict the disclosures made herein. Where arrows are utilized in the drawings, it would be appreciated by one of ordinary skill in the art that the arrows represent the interconnection of elements and/or components via buses or any other type of communication channel.

The present invention can be implemented in any general purpose or special purpose processor. An exemplary processing system includes a chip architecture having scalable, distributed processing and memory capabilities through a plurality of processing layers, as disclosed in PCT/US06/00622 and pending U.S. patent application Ser. No. 11/813,519, which is incorporated herein by reference. Other exemplary processors are disclosed in U.S. Pat. Nos. 6,226,735, 6,122,719, 6,108,760, 5,956,518, and 5,915,123, all of which are incorporated herein by reference. Exemplary processors further include hybrid digital signal processors (DSPs)/RISC chips that have adaptive instruction sets and instruction set architectures that can be dynamically customized to match the particular requirements of the running applications. Of particular importance are processors that can afford big sigma filter windows, e.g. on the order of 9×5 as opposed to conventional 5×5 or 3×3 sizes.

In one exemplary embodiment, the processors are used to execute novel methods of noise estimation that are equally capable of minimizing Gaussian noise and the noise introduced by video encoding-decoding process, blocky noise. The noise estimation method of the present invention provides a measurement of noise in the form of standard deviation. Once estimated, the method of the present invention uses directional high-pass filtering to reduce the effect of noise without degrading the image quality. While these embodiments are described as being executed by one or more processing units in the DPLP, it should be appreciated that these processing methodologies can be implemented in a processing unit that is completely separate from, and independent of, the DPLP.

The coding schemes employed in video images generate decompressed images that sometimes exhibit artificial discontinuities between image blocks. These blocking artifacts are caused, at least in part, by quantization during the quantization step of the compression process. For example, in block-based coding, such as discrete cosine transform (DCT), monotone areas of the original image, where the pixel intensity changes gradually, suffer from the abrupt changes across the block boundary, leading to blocking artifacts. Also, visually annoying noise near real edges, which is called ringing noise, occurs in the block-based DCT scheme.

Since the noise introduced by encoding-decoding process manifests itself as slightly blocky structures consisting of 8×8 pixel blocks, the noise estimation method of the present invention uses a bigger window for estimation purposes, with each window containing several 8×8 blocks in each direction. The window size is determined based on the size of the smallest noticeable area of constant luminance. In one embodiment, the window size is 32×32 pixels.

The noise estimation method of the present invention minimizes both 32×32 homogeneity, as well as the noise variance together over the entire frame. The 32×32 homogeneity is the normalized sum of absolute values of possible 5×5 homogeneities inside 32×32-pixel window. For a 32×32 pixel window, homogeneity can be calculated using the following equation:

$$Homogeneity = NORM * {\sum }_{k = 1}^{8} {\sum }_{m = 0}^{27} {\sum }_{n = 0}^{27} \vert {\sum }_{j = 0}^{4} {\sum }_{i = 0}^{4} {M}_{i , j}^{k} * {PIX}_{i + n , j + m} \vert$$

$$NORM = 1 / ( 8 * 28 * 28 ) for 32 \times 32 window$$

| . . . | defines absolute value;
M_{i,j}^{k} means element i, j of matrix M^{k} for high-pass directional filtering;
PIX_{i+n, j+m} means pixel value in the position (i+n, j+m).

For further background on its calculation, see A. Amer et al., “Fast and Reliable Structure-Oriented Video Noise Estimation”, IEEE Transactions on Circuits and Systems for Video Technology, 2005, v. 15, N1. pp. 113-118, which is incorporated herein by reference.

One major advantage of the present noise estimation is that it requires input pixels from one frame only. Further, it requires no preliminary knowledge of noise level expected. Commonly, a processing device receives a video stream without any information about the noise level. Moreover, noise level might be different for different parts of a stream. Prior art approaches estimate noise as a variance of pixel differences between two adjacent frames, which can be an acceptable approach if there is no motion, both frames are accessible, and processing speed is not at a premium.

The present invention does not require the use of two adjacent frames. Rather, it estimates noise by first identifying a smooth area within a frame and then estimating the minimum variance in that smooth area, eliminating the need for a second frame. More specifically, the variance of pixel values in an area of a frame represents the noise level. The present invention optimally selects the proper area of a frame to calculate the minimum variance by identifying a sufficiently smooth area within the frame. Human eyes mostly recognize noise on very smooth background. Therefore, high-frequency color variations of clear blue sky or gray wall provide a sufficiently smooth area for noise estimation. Where there are several suitable zones in the frame, the present invention identifies the zone with minimal variance for use in noise estimation.

For a given pixel, the noise estimation method of the present invention uses a small sliding window of M×N (for example 32×32) input pixels around the current pixel, and makes use of the following adjustable parameters for computations:
Maximum Ratio of acceptable variances
Minimum Ratio of acceptable variances
Window size
Number of pixels to skip between adjacent windows
Maximum and Minimum luminance values for a pixel

The noise estimation method of the present invention assumes that the frame under consideration contains a large area of almost constant luminance value, where the size of this area is comparable or bigger than the window size.

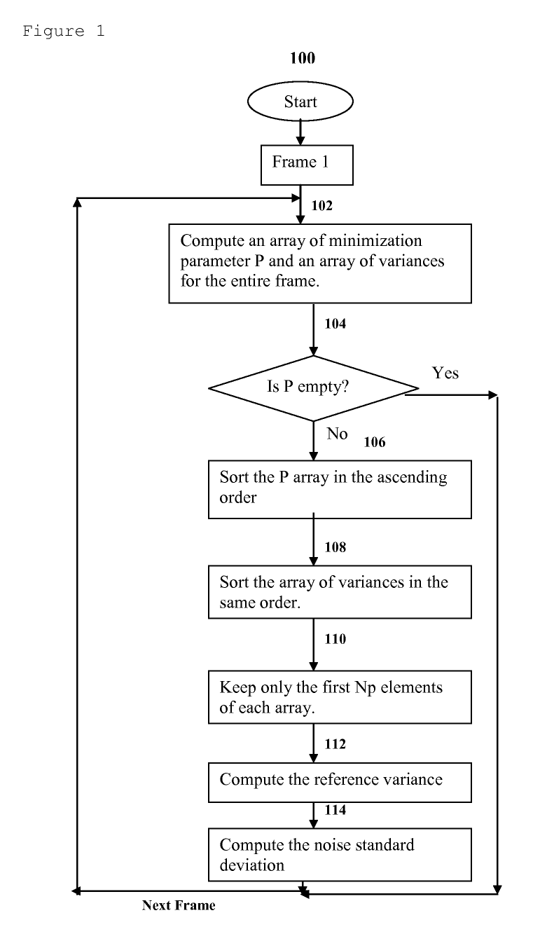

FIG. 1 depicts a plurality of steps comprising the noise estimation method of the present invention. These steps, illustrated by means of a flow chart 100, are performed once per frame. Thus, for each frame, the first step involves computing an array of “minimization” parameter P and an array of variances for the entire frame, as shown in 102. In the next step 104, it is determined whether the array, P, is empty. If it is empty, it implies that no noise estimation can be done for that frame, and the next frame is considered for noise estimation. However, if P is not empty, then the array P is sorted in ascending order 106. Next, the array of variances is also sorted in the same order 108. For both the arrays, only the first Np elements of each array are retained, as shown in step 110. Thereafter, the reference variance is computed 112, which is used for the computation of the noise standard deviation 114.

Further details of the individual steps that form the computational core of the noise estimation process are described as follows.

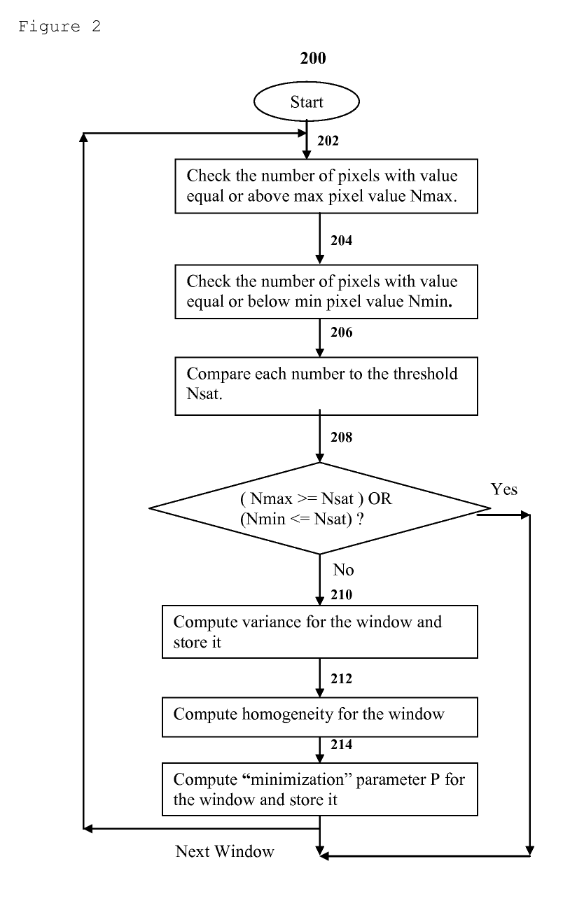

FIG. 2 illustrates the steps in computing the array of “minimization” parameter P and the array of variances for a given frame. For computing these arrays, the following computations are applied to each window of M×N input pixels. By way of example only, a window size of 32×32 pixels, with a sliding step (number of pixels to skip between adjacent windows) of 3 pixels horizontally and vertically is considered for computations. It should be appreciated that other window sizes and pixel steps can be used.

In the first step 202, the number of pixels with value equal or above maximum pixel value “Nmax” is checked. In step 204, the number of pixels with value equal or below minimum pixel value “Nmin” is determined. Each of these numbers are then compared 206 to the threshold pixel value “Nsat”. The value of Nsat in the exemplary embodiment is 2.

Nmax is the number of pixels in a 32×32 window with a maximum possible color value. It is calculated for each 32×32 window. It should be appreciated that, for a given color space, pixel values occupy some value range. For example, in the RGB color space all pixels are 8-bit values from 0 to 255; in the YUV color space, pixel luminance is in the range of [16, 235] and both chrominance are in the range of [16, 240]. If pixel value is at a maximum, then pixel color is completely saturated, and all information about noise would be lost. Therefore, such pixels should be excluded from noise estimation process. If there are too many of them, that particular 32×32 window should not be used in the estimation process at all. Similarly, while Nmax determines the prevalence of saturated color, Nmin calculates the minimum possible color values. Nsat is the number of pixels with minimum or maximum color value allowed in the window. This is an adjustable parameter and can be varied depending upon the application. In one embodiment, as discussed above, Nsat is set to 2.

If, for the current window, the value of Nmax is greater than or equal to Nsat, or if Nmin is less than or equal to Nsat, then computations for that window cannot be carried out. In such a case, the current window is skipped and the next one is considered for proceeding with the computations. This is shown in step 208.

The following computations are then carried out in the next steps 210 and 212:
variance for the window and
homogeneity for the window

From the values of variance and homogeneity, the “minimization” parameter P for the window is computed and stored 214.

The variance for the window as mentioned in step 210, is computed on the basis of the following formulae:

Mean=Norm*Sum(Pi),

Mean2=Norm*Sum(Pi*Pi),

Variance=Mean2−Mean*Mean
Wherein “i” is the ith pixel in the window and i=1, 2, . . . , M*N;
Pi is the value of the ith pixel in the window; and
Norm=1/(M*N).

For computational purposes, a 10-bit pixel value is assumed, and the format of computed variance is 20-bit unsigned integer.

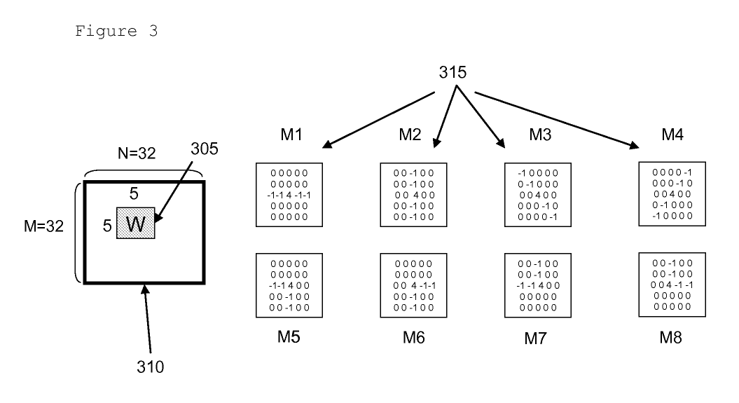

For computing the homogeneity as mentioned in step 212, all 5×5 windows 305 within the 32×32 window 310 are considered. This is shown in FIG. 3. Thus, referring to FIG. 3, and as mentioned previously, the 32×32 homogeneity 310 computed in the method of the present invention, is the normalized sum of absolute values of all possible 5×5 homogeneities 315 inside 32×32 pixel window 310. With reference to FIG. 3, the value of homogeneity for a 32×32 window 310 is computed on the basis of the following formulae:

Accum=SUMj(SUMi(abs(SUM(Wj.*Mi)))); format−unsigned 26-bit integer

Norm=1/(8*(M−4)*(N−4)); format−unsigned 13-bit fractional

Homogeneity=Norm*Accum; format−unsigned 13-bit integer
Wherein i=1, . . . , 8 and j is all 5×5 windows inside a 32×32 window.

After the variance and homogeneity for a window have been computed as described above, the minimization parameter P for the window is computed using the following formula:

P=homogeneitŷ2+variance. The format for the value of P is 27-bit unsigned integer.

After the minimization parameter P and the variance for each window in a frame has been computed, it yields an array of parameter P values and another array of variances where the arrays correspond to the values of the minimization parameter P and the values of variances for the entire frame. After computing the two arrays, both the arrays are sorted in ascending order, as mentioned previously with reference to FIG. 1. For the purpose of further computations in noise estimation, only the smallest “Np” number of values of P and corresponding values of variances are considered. In the exemplary embodiment, the value of Np is 8.

One of ordinary skill in the art would appreciate that for the purpose of selecting the smallest “Np” number of values of P and corresponding values of variances, the two arrays may be sorted in either ascending or descending order.

After sorting the arrays and retaining the smallest Np values, the reference variance is computed, as mentioned previously with reference to step 112 of FIG. 1. The following equation is employed in calculating the reference variance:

reference variance=MEDIAN(variance[0], variance[1], variance[2]). The format for the reference variance is 20-bit unsigned integer.

Finally, the value of noise standard deviation is calculated on the basis of the value of reference variance obtained in accordance with the following equations:

1) Max. Variance=Max. Ratio*reference variance; wherein the Max. Variance is the upper limit for acceptable variance, with the format being an unsigned 24-bit integer, 1-bit fractional; and the Max. Ratio is the Maximum Ratio of acceptable variances. In the exemplary embodiment, Max. Ratio=2 and its format is unsigned 4-bit integer, 4-bit fractional.

2) Min. Variance=Min. Ratio*reference variance; wherein the Min. Variance is the lower limit for acceptable variance, with the format being an unsigned 24-bit integer, 1-bit fractional; and the Min. Ratio is the Minimum Ratio of acceptable variances. In the exemplary embodiment, Min. Ratio=0.5 and its format is unsigned 4-bit integer, 4-bit fractional.

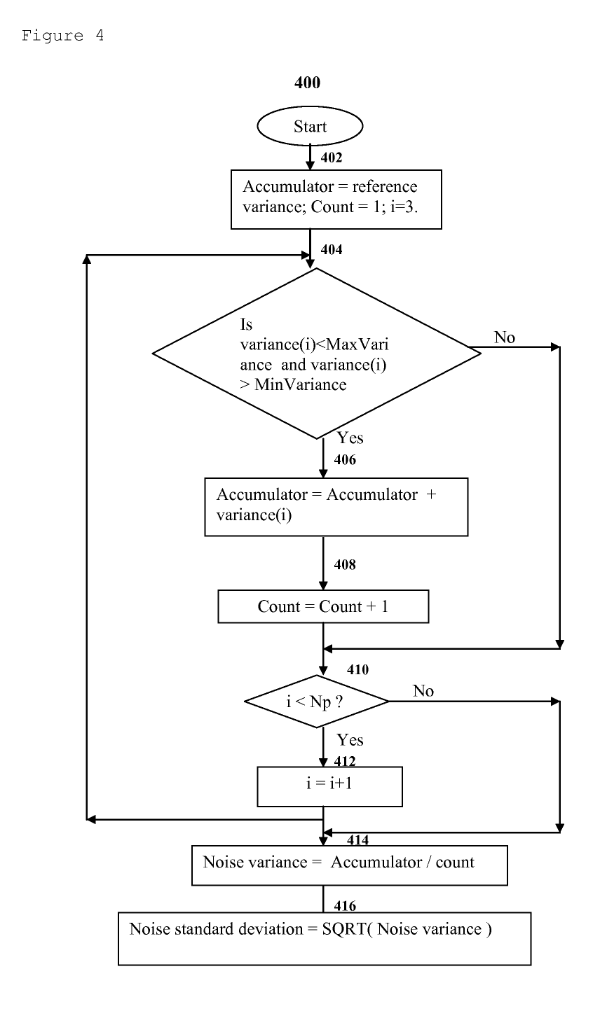

For calculating the value of noise standard deviation, all acceptable variances are accumulated in the Accumulator, which is an unsigned 32-bit integer, and a count of these variances is established. The count is an unsigned 6-bit integer. The method of computing noise standard deviation using the values of Accumulator and count is illustrated by means of a flow chart in FIG. 4.

Referring to FIG. 4, initially, the value of Accumulator is set to the value of reference variance and the value of count is set to 1, as shown in step 402. The following steps are then repeated Np times; as mentioned earlier, the value of Np in the exemplary embodiment is 8.

The ith variance value in the array of variances, variance(i), wherein the value of “i” varies from 1 to Np, is compared to the values of Max. Variance and Min. Variance. This is depicted in step 404. If the value variance(i)is less than that of Max. Variance and also the value of variance(i) is more than the Min. Variance value, then the value of variance(i) is added to the accumulator value. That is, Accumulator=Accumulator+variance(i), and the count value is incremented by 1.

This is illustrated in steps 406 and 408. The steps 406 and 408 are repeated Np times (as shown by 410 and 412), and thereafter the final values of accumulator and count thus obtained are used to calculate the Noise variance in accordance with the following equation:

Noise variance=Accumulator/count;

This computational step is depicted in step 414. From the value of Noise variance, the Noise standard deviation is calculated in step 416 using the following formula:

Noise standard deviation=SQRT(Noise variance);

Where SQRT is a square root function.

After the value of noise standard deviation is determined, which provides an estimate of the noise in a given video frame, reduction of this noise may be attempted using any of the filtering approaches known in the art such as spectral subtraction, Bayesian approach with weighted Gaussian Approximation, adaptive filtering, or adaptive spatial filtering.

One of ordinary skill in the art would appreciate that the noise estimation and reduction method are implemented in the form of processor instructions, stored in a memory, that are accessible to a processor which acts on a video data stream, obtained from a memory, using the instructions. Further, although the noise estimation method of the present invention has been described with reference to its application to video, one of ordinary skill in the art would appreciate that this method may also be employed for accurate assessment of noise in other types of data such as still images and graphics.

Although described above in connection with particular embodiments of the present invention, it should be understood the descriptions of the embodiments are illustrative of the invention and are not intended to be limiting. Various modifications and applications may occur to those skilled in the art without departing from the true spirit and scope of the invention as defined in the appended claims.

We claim:

1. A method of filtering noise in a single frame of video data:
a. Obtaining a single frame of video data within a memory; and
b. Executing a plurality of instructions within a processor wherein, when executed, the instructions:
i. identify a window within said single frame;
ii. compute a variance of said window;
iii. derive a noise estimation from said variance; and
iv. filter said noise from said single frame using said noise estimation.

2. The method of claim 1 wherein said filtering is effective to remove Gaussian noise and blocky noise.

3. The method of claim 1 wherein the window is identified by obtaining a plurality of windows within said frame wherein each window comprises M×N pixels.

4. The method of claim 3 wherein the plurality of windows are separated by a predetermined number of pixels.

5. The method of claim 4 wherein M is equal to 32, N is equal to 32 and the predetermined number of pixels is 3.

6. The method of claim 3 wherein said instructions calculate the maximum pixel values for each plurality of windows comprising M×N pixels.

7. The method of claim 6 wherein said instructions calculate the minimum pixel values for each plurality of windows comprising M×N pixels.

8. The method of claim 7 wherein said instructions compare said minimum pixel values and said maximum pixel values to at least one threshold value.

9. The method of claim 8 wherein said instructions eliminate windows from a variance calculation if said minimum pixel values for said windows are below the threshold value or if said maximum pixel values for said windows are above the threshold value.

10. The method of claim 8 wherein said instructions calculate the variance for windows wherein said windows have minimum pixel values for said windows below the threshold value and said windows have maximum pixel values for said windows above the threshold value.

11. The method of claim 10 wherein said instructions calculate the homogeneity for windows wherein said windows have minimum pixel values for said windows below the threshold value and said windows have maximum pixel values for said windows above the threshold value.

12. The method of claim 10 wherein said instructions obtain an array of variances.

13. The method of claim 12 wherein said variances in the array are sorted.

14. The method of claim 12 wherein said instructions compute a reference variance from the array of variances.

15. The method of claim 14 wherein a noise standard deviation is derived from said reference variance.

16. The method of claim 15 wherein the noise estimation is derived from said noise standard deviation.

17. A method of filtering Gaussian noise and blocky noise in a single frame of video data:
a. Obtaining a single frame of video data within a memory; and
b. Executing a plurality of instructions within a processor wherein, when executed, the instructions:
i. identify a plurality of windows within said single frame;
ii. select a subset of said windows based on whether a maximum pixel value for each of said windows exceeds a threshold value and whether a minimum pixel value for each of said windows is below said threshold value;
iii. compute variances for said selected subset of windows;
iv. compute an array of variances based upon said computed variances;
v. derive a reference variance from said array of variances;
vi. derive a noise standard deviation from said reference variance;
vii. derive a noise estimation from said noise standard deviation; and
viii. filter said noise from said single frame using said noise estimation.

18. The method of claim 17 wherein said instructions eliminate windows from a variance calculation if said minimum pixel values for said windows are below the threshold value or if said maximum pixel values for said windows are above the threshold value.

19. The method of claim 17 wherein said instructions calculate a homogeneity for windows wherein said windows have minimum pixel values for said windows below the threshold value and said windows have maximum pixel values for said windows above the threshold value.

20. A system for filtering Gaussian noise and blocky noise in a single frame of video data:
a. A memory for storing a single frame of video data;
b. A processor in data communication with said memory; and
c. A plurality of instructions stored within a memory accessible to said processor wherein, when executed, the instructions:
i. identify a plurality of windows within said single frame;
ii. select a subset of said windows based on whether a maximum pixel value for each of said windows exceeds a threshold value and whether a minimum pixel value for each of said windows is below said threshold value;
iii. compute variances for said selected subset of windows; iv. compute an array of variances based upon said computed variances; v. derive a reference variance from said array of variances; vi. derive a noise standard deviation from said reference variance; vii. derive a noise estimation from said noise standard deviation; and viii. filter said noise from said single frame using said noise estimation.
